(19) United States
(12) Patent Application Publication
(10) Pub. No.: US 2024/0405873 A1
(43) Pub. Date: Dec. 5, 2024

(54) SPACE SYSTEM AND METHOD FOR WIRELESS COMMUNICATION BY TRANSMITTING RADIOFREQUENCY AND OPTICAL SIGNALS ON A RETURN CHANNEL

(71) Applicant: THALES, MEUDON (FR)

(72) Inventor: Tarik BENADDI, Toulouse (FR)

(21) Appl. No.: 18/679,275

(22) Filed: May 30, 2024

(30) Foreign Application Priority Data
Jun. 1, 2023 (FR) 2305491

(51) Int. Cl. H04B 10/118; H04B 7/185; H04L 1/00

(52) U.S. Cl. CPC H04B 10/118; H04B 7/1851; H04L 1/0071

(57) ABSTRACT

A communication satellite configured to transmit an optical signal, through an optical transmission channel, in response to the reception of at least one modulated and encoded radiofrequency signal. The satellite comprises: a unit for applying soft demodulation to the at least one received radiofrequency signal, and providing N intermediate demodulated data frames B₁₋ₙ, each frame B₁₋ₙ comprising a set of digitized soft values; a unit for applying an error correction code to the frames B₁₋ₙ, and providing N encoded intermediate demodulated data frames B₂₋ₙ; a unit for interleaving the N frames B₂₋ₙ, and providing M interleaved data frames I₂₋ₘ; and a unit for applying, to each frame I₂₋ₘ, an optical carrier modulation so as to form the optical signal.

### CROSS-REFERENCE TO RELATED APPLICATION

This application claims priority to foreign French patent application No. FR 2305491, filed on Jun. 1, 2023, the disclosure of which is incorporated by reference in its entirety.

### TECHNICAL FIELD

The present invention relates in general to the field of space communications, and in particular to a system and method for wireless communication using optical signal transmissions for the return channel.

### BACKGROUND

Over the past years, new telecommunications services requiring increased throughputs have developed significantly, following strong competition in the field of terrestrial communication networks. In particular, to address the need to bridge the digital divide in order to allow all users to enjoy the same quality of service wherever they are, including users who might not be connected to the terrestrial network, the transmission capacity needs of satellite operators have become very great and have necessitated the deployment of improved very high-throughput systems (HTS/VHTS/UHTS for high/very high/ultra high-throughput systems).

However, these capacity demands are such that, at present, traditional satellite-based wireless communication technologies are reaching their limits. Indeed, such technologies based on the transmission of radiofrequency (RF) waves experience saturation of the usable RF spectral bands, are subject to strict regulatory constraints, and have significant limits. In this context, optical technologies, capitalizing on developments in very high-throughput fiber-optic terrestrial telecoms, are a promising alternative for very high-throughput data transmission for a wide spectrum of applications, such as telecoms satellite megaconstellations, very high-capacity geostationary satellites, high-throughput satellite-to-user point-to-point links, transmission of large volumes of observation data from satellites to ground, etc. In addition, these optical technologies make it possible to access to wide frequency bands that are less congested than RF signals and are unlicensed, to achieve very high throughputs and to reduce the size of on-board and ground terminals.

However, satellite links for wireless optical communications through the atmosphere are subject to more adverse propagation effects than radiofrequency links. Indeed, the composition of the layers of the atmosphere and atmospheric turbulence induce strong degradation on an optical signal and generate deep fading, thus interrupting the transmission of services for several milliseconds.

There are some solutions for satellite systems for wireless communication using optical technologies and, in particular, signal interleaving methods for overcoming this problem of optical signal fading.

What are known as “regenerative” satellite architectures have notably been proposed in a wireless communications system using, for the return channel, the complete regeneration of the data from the demodulation and decoding function of the RF signal transmitted by service user equipments. However, such a regenerative architecture has the drawback of requiring a highly complex implementation on board the satellite. Indeed, regenerative architectures are difficult to implement given the complexity of RF signal reception processing and the very large number of RF carriers to be considered in the case of a deployment of VHTS systems.

What are known as “transparent” satellite architectures are also envisaged in a wireless communications system using, for the return channel, the direct digitization of the RF carriers transmitted by service user equipments. However, such digitization requires the use of a high sampling frequency according to the Nyquist criterion and a very high number of quantization bits, for example greater than around ten bits per sample. Due to such oversampling, the transparent architecture has the drawback of a large expansion of the spectral occupancy of the signals transmitted on the optical downlink in order to be able to transmit the high throughput of the digitized RF carriers. The use of a wide optical spectral band also leads to the implementation of a larger number of equipments such as high-power optical amplifiers or multiplexers, for example on board the satellite.

These transparent and regenerative architectures thus have almost inevitable drawbacks that hamper their short-term and medium-term deployment.

There is thus a need for an improved satellite system for wireless communication using optical technologies.

### SUMMARY OF THE INVENTION

The present invention aims to improve the situation by proposing a communication satellite configured to transmit an optical signal, through an optical transmission channel, in response to the reception of at least one modulated and encoded radiofrequency signal. The satellite comprises:
a soft demodulation unit configured to apply soft demodulation to the at least one received radiofrequency signal, thereby providing a plurality of N intermediate demodulated data frames B₁₋ₙ, each intermediate demodulated data frame B₁₋ₙ comprising a set of digitized soft values;
an encoding unit configured to apply an error correction code to the intermediate demodulated data frames B₁₋ₙ, thereby providing a plurality of N encoded intermediate demodulated data frames B₂₋ₙ;
an interleaving unit configured to interleave the N encoded intermediate demodulated data frames B₂₋ₙ, thereby providing M interleaved data frames I₂₋ₘ; and
an optical carrier modulation unit configured to apply, to each interleaved data frame I₂₋ₘ, an optical carrier modulation so as to form the optical signal.

In some embodiments, for each intermediate demodulated data frame B₁₋ₙ, the digitized soft values may be defined with a Gaussian distribution. The error correction code applied by the encoding unit may take into account the Gaussian distribution of the digitized soft values of the frames B₁₋ₙ.

Advantageously, for each intermediate demodulated data frame B₁₋ₙ, each quantization bit of the digitized soft values may be associated with a significance index. The error correction code applied by the encoding unit may take into account the significance index of the bits of the digitized soft values of the frames B₁₋ₙ.

The present invention additionally proposes a communication station configured to receive, through an optical transmission channel, an optical signal associated with a plurality of initial data frames T_{0-q}. The communication station comprises:
a demodulation unit configured to demodulate the received optical signal, thereby providing M demodulated interleaved data frames I*₂₋ₘ;
a deinterleaving unit configured to deinterleave the M demodulated interleaved data frames I*₂₋ₘ, thereby providing a plurality of N deinterleaved data frames B*₂₋ₙ;
a decoding unit configured to apply a reciprocal function of an error correction code to the deinterleaved data frames B*₂₋ₙ, thereby providing a plurality of N decoded data frames B*₁₋ₙ, each frame B*₁₋ₙ comprising a set of digitized soft values; and
a decoding unit configured to apply a digitized soft value decoding function to the set of N decoded data frames B*₁₋ₙ, thereby providing a plurality of N regenerated data frames T*₀₋ₙ, each regenerated data frame T*ₒ₋ₙ corresponding to a reconstituted initial data frame T₀₋ₙ.

In some embodiments, the reciprocal function of the error correction code applied by the decoding unit may take into account a Gaussian distribution of the soft values of the generated decoded data frames B*₁₋ₙ.

Advantageously, the reciprocal function of the error correction code applied by the decoding unit may take into account a significance index associated with each bit of the soft values of the generated decoded data frames B*₁₋ₙ.

The embodiments of the invention thus provide a wireless communication system comprising a communication satellite and a communication station, which are connected by an optical transmission channel. The communication station is configured to receive the optical signal from the communication satellite through the optical transmission channel, the reciprocal function being the reciprocal function of the error correction code applied by the communication satellite.

In some embodiments, the communication satellite may furthermore comprise a soft value frame compression unit and the communication station may furthermore comprise a soft value frame decompression unit.

Also proposed is a method for transmitting an optical signal, the method being implemented in a communication satellite connected to an optical transmission channel. The method comprises the following steps:
receiving at least one modulated and encoded radiofrequency signal;
applying soft demodulation to the at least one received radiofrequency signal in order to determine a plurality of N intermediate demodulated data frames B₁₋ₙ, each frame B₁₋ₙ comprising a set of digitized soft values;
applying an error correction code to the intermediate demodulated data frames B₁₋ₙ in order to determine a plurality of N encoded intermediate demodulated data frames B₂₋ₙ;
applying an interleaving function to the encoded intermediate demodulated data frames B₂₋ₙ in order to determine M interleaved data frames I₂₋ₘ;
applying optical carrier modulation to each interleaved data frame I₂₋ₘ, thereby providing the optical signal; and
transmitting the optical signal through the optical transmission channel.

Also proposed is a method for receiving an optical signal, the method being implemented by a communication station connected to an optical transmission channel. The method comprises the following steps:
receiving the optical signal associated with a plurality of initial data frames T_{o-q}, through the optical transmission channel;
applying demodulation to the received optical signal, thereby providing M demodulated interleaved data frames I*₂₋ₘ;
applying a deinterleaving function to the demodulated interleaved data frames I*₂₋ₘ, thereby providing a plurality of N deinterleaved data frames B*₂₋ₙ;
applying a reciprocal function of an error correction code to the deinterleaved data frames B*₂₋ₙ, thereby providing a plurality of N decoded data frames B*₁₋ₙ, each frame B*₁₋ₙ comprising a set of digitized soft values; and
applying a digitized soft value decoding function to the set of N decoded data frames B*₁₋ₙ in order to determine a plurality of N regenerated data frames T*₀₋ₙ, each regenerated data frame T*₀₋ₙ corresponding to a reconstituted initial data frame T₀₋ₙ.

The embodiments of the invention make it possible to improve wireless satellite communication in terms of data transmission performance for the return channel and in terms of occupied optical spectral band.

They make it possible to achieve a solution that is affordable, in terms of hardware complexity to be implemented, of mature technological accessibility able to be applied in space at present, and of energy consumption (digital processing resources for memory storage, for example) on board the satellite, thus shifting much of this complexity to the ground communication station.

They also make it possible to implement a data interleaving solution on board the satellite and compensate for turbulence in the optical channel.

The use of optical technologies and wavelengths, in the wireless communication system according to the embodiments of the invention, makes it possible to benefit from the absence of optical frequency regulation, high accessible throughputs, the wide availability and low cost of proven optical components on the ground that benefit research and development efforts in terrestrial telecoms. It also enables a reduction in the mass/consumption of optical equipments, possible synergy with terrestrial networks, and possible synergy with photonic payloads on board the satellite.

### BRIEF DESCRIPTION OF THE DRAWINGS

Other features, details and advantages of the invention will become apparent on reading the description provided with reference to the appended drawings, which are given by way of example.

FIG. 1 is a diagram showing a wireless communication system, according to some embodiments of the invention.

FIG. 2 is a diagram showing a wireless communication device, according to some embodiments of the invention.

FIG. 3 is a diagram showing a satellite comprising a wireless communication payload, according to some embodiments of the invention.

FIG. 4 is a diagram showing a communication station, according to some embodiments of the invention.

FIG. 5 is a flowchart showing those steps of the wireless communication method implemented by the wireless communication payload, according to some embodiments of the invention.

FIG. 6 is a flowchart showing those steps of the wireless communication method implemented by the communication station, according to some embodiments of the invention.

Identical references are used in the figures to denote identical or similar elements. For the sake of clarity, the elements that are shown are not to scale.

### DETAILED DESCRIPTION

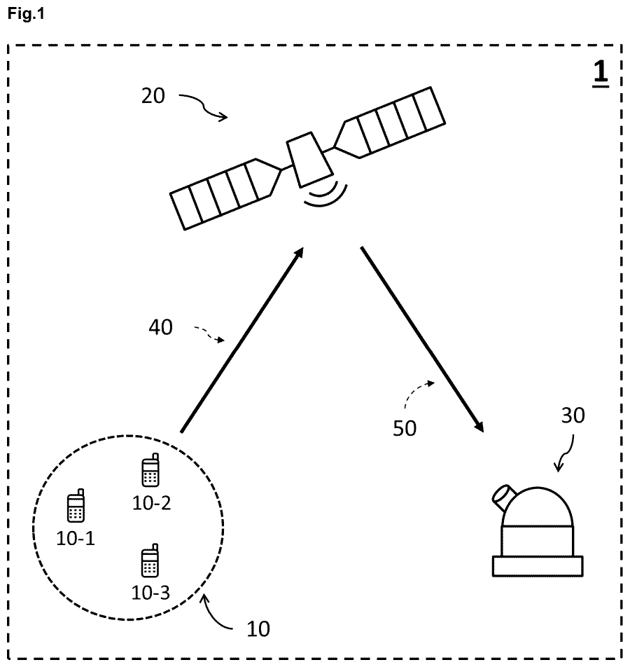

FIG. 1 schematically shows a wireless communication system 1 comprising a set of elements communicating with one another, according to some embodiments of the invention.

The wireless communication system 1 is a non-terrestrial network (NTN) communication infrastructure applied to the field of space communications. By way of illustration, the system 1 may comprise a set 10 of Q wireless communication terminals 10-q, a satellite communication platform 20 and an associated communication station 30.

The set 10 corresponds to the wireless communication terminals served in the area of coverage of the satellite communication platform 20. A wireless communication terminal 10-q (also called a ‘terminal station’ or ‘client device’) denotes a user equipment (UE) configured to transmit and receive data through the system 1. The user equipment, used by an end user, is configured to consume and/or create a service via one or more heterogeneous access communication networks based on a variety of access technologies, standards and protocols. The number Q of terminals in the system is a positive integer greater than or equal to 1. The parameter ‘q’ designates an index associated with any wireless communication terminal of the system, and is an integer between 1 and Q.

The satellite communication platform 20 (also called a ‘space platform’ or ‘satellite’) may be any type of communication satellite orbiting above the Earth's surface and configured to serve an area of coverage associated with the set 10 of wireless communication terminals 10-q. According to the implementation of the invention, the wireless communication system 1 may comprise one or more space platforms 20 configured in one or more constellations for providing global, national, supranational or regional coverage for sets of wireless communication terminals. The one or more space platforms 20 may be deployed at various altitudes in various orbits around the Earth to facilitate service coverage over various geographical areas. In some representative embodiments, the space platforms may be stationed in a geosynchronous or geostationary Earth orbit (GSO or GEO) at an altitude of 35,786 km above the Earth's surface with an orbital period of 24 hours. In other exemplary embodiments, the space platforms may be stationed for example in a medium Earth orbit (MEO) closer to the Earth's surface, in a low Earth orbit (LEO), or else in what are known as highly elliptical orbits (HEO).

The communication station 30 may be a service gateway switching node (or ‘gateway node’ or gateway station), which may be coupled to one or more terrestrial communication networks (not shown in the figures). Such a gateway node 30 thus forms a gateway between the non-terrestrial network communication infrastructure and any type of network or combination of terrestrial communication networks.

As used here, the term “service” refers to telephony services, data services or any other service offered by access network providers, to users or subscribers via a user equipment. For example and without limitation, the services may be satellite-based communications (voice, data, text, video and/or Internet), satellite-based terrestrial mobile services, satellite-based maritime mobile services, multimedia broadcasting services, navigation and global positioning services, etc. A service may be constructed based on a first-generation (1G), second-generation (2G), third-generation (3G), fourth-generation (4G) or fifth-generation (5G) cellular communication protocol, a high-speed packet access (HSPA), high-speed downlink packet access (HSDPA) or high-speed uplink packet access (HSUPA) protocol, an Internet of Things (IoT) protocol, a Digital Video Broadcasting-Satellite (DVB-S) protocol, a second-generation DVB-S (or DVB-S2), DVB-S2 extension communication (or DVB-S2X), DVB-S return channel (or DVB-RCS), second-generation DVB-RCS (or DVB-RCS2) protocol, etc. Examples of user equipment may thus comprise satellite telephones, multi-mode non-terrestrial network communication terminals, terrestrial cellular or Wi-Fi communication terminals, as well as (manual and/or autonomous) connected vehicles, networked or local gaming consoles, multimedia players, and any portable or wearable device such as smartwatches, laptops, tablets, mobile telephones, IoT sensors, or augmented reality, virtual reality or mixed reality devices, etc.

The wireless communication system 1 comprises a first transmission channel 40 (commonly called a user link) for one or more links, established between the set 10 of communication terminals and the space platform 20, as well as a second transmission channel 50 (commonly called a feeder link) for one or more other links, established between the space platform 20 and the associated communication station 30. In the remainder of the description, the transmission channel 50 will also be called an ‘optical channel’.

Each transmission channel 40 or 50 comprises uplinks (or UL) and downlinks (or DL). The links UL and DL of one and the same transmission channel are in the same frequency band or in different frequency bands. For the first transmission channel 40, the links UL correspond to the transfer of data from the terminals 10-q to the space platform 20, and the links DL correspond to the transfer of data from the space platform 20 to the terminals 10-q. For the second transmission channel 50, the links UL correspond to the transfer of data from the communication station 30 to the space platform 20, and the links DL correspond to the transfer of data from the space platform 20 to the communication station 30. Finally, the links between the communication station 30 and the terminals 10-q, via the space platform 20, also called ‘round-trip’ communications, comprise an outward channel and a return channel. The outward channel corresponds to the links UL between the communication station 30 and the space platform 20, associated with the links DL between the space platform 20 and the terminals 10-q. Similarly, the return channel, as shown in FIG. 1, corresponds to the links UL between the terminals 10-q and the space platform 20, associated with the links DL between the space platform 20 and the communication station 30.

According to some embodiments of the present invention, the wireless communication system 1 comprises the use of a first set of frequencies or frequency bands λ₁ to implement the links UL through the first transmission channel 40 in order to transfer data from the terminals 10-q to the space platform 20. The wireless communication system 1 also comprises the use of a second set of frequencies or frequency bands λ₂ to implement the links DL through the second transmission channel 50 in order to transfer data from the space platform 20 to the associated communication station 30. The embodiments of the invention make it possible to process information transfers along the return channel of a wireless communication system 1.

Advantageously, the first set of frequencies λ₁ is in the radiofrequency (RF) region, such that the links UL implemented through the first transmission channel 40 correspond to the transmission of radiofrequency signals. For example and without limitation, the first set of frequencies λ₁ may correspond to an “X band” RF band typically between 8 GHz and 12 GHz, to a “K band” RF band typically between 22.5 GHz and 27 GHz, or else to a “Ka band” RF band typically between 27 GHz and 40 GHz.

Advantageously, the second set of frequencies λ₂ is in the optical region, such that the links DL implemented through the second transmission channel 50 correspond to the transmission of signals referred to as optical signals. In particular, the second set of frequencies λ₂ may correspond to a wavelength or to a wavelength interval located in the infrared (IR), near-infrared and far-infrared regions. For example and without limitation, the second set of frequencies λ₂ may correspond to the wavelength of 1550 nm.

Each device 10-q of the wireless communication system 1 is therefore configured to generate one or more radiofrequency communication signals constructed based on a communication protocol. Such radiofrequency communication signals are then radiofrequency signals modulated and encoded based on data to be transmitted.

The communication protocol used to form such radiofrequency communication signals may for example be defined according to the DVB-RCS2 (Digital Video Broadcasting—Return Channel via Satellite—Second Generation) satellite-based multimedia content transmission standard established by the ETSI (European Telecommunications Standards Institute) standardization body.

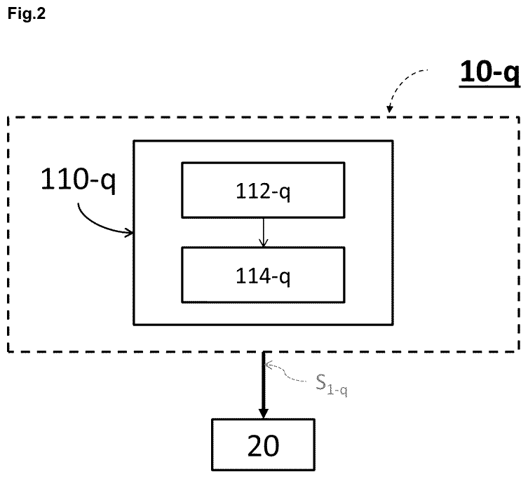

For example, each wireless communication terminal 10-q may comprise a signal generation module 110-q as shown schematically in FIG. 2, and a radiofrequency NTN transmitter 120-q not shown in the figures.

In some embodiments, the signal generation module 110-q may comprise an initial data encoding unit 112-q configured to apply a first error correction code to an initial data frame T_{0-q} so as to determine an encoded data frame T_{1-q}.

As used here, the expression ‘data frame’ refers to data packets comprising sets of values or bits (that is to say consecutive digital elements) specified according to a communication protocol.

An error correction code (or FEC (forward error correction) code) is a technique, in information theory, for detecting and correcting errors that affect data transmitted on a noisy channel. The principle of this technique is that of adding (or concatenating), at a transmitter, redundancy information to the data frame to be transmitted. This redundancy information is then used by a receiver to check and correct errors in the received data frame. Examples of known FEC codes are Reed Solomon codes, used in digital communications, low-density parity-check (LDPC) codes, or else turbo codes.

For example and without limitation, the first error correction code may be a concatenation of the initial data frame T_{0-q} with a first redundancy frame Tᵢ to form the encoded data frame T_{1-q}. The first redundancy frame Tᵢ then corresponds to a set of parity bits, that is to say a set of bits computed with respect to the information bits of the initial data frames T_{0-q}.

The signal generation module 110-q may also comprise an RF carrier data modulation unit 114-q configured to apply amplitude and/or phase modulation of a radiofrequency signal, depending on the encoded data frame T_{1-q}, so as to form a radiofrequency communication signal to be transmitted via the radiofrequency NTN transmitter 120-q through the first transmission channel 40. Thus, each frame T_{1-q} modulated onto an RF signal and transmitted by a terminal of the set 10 comprises a redundancy of the same or more redundancy frames Tᵢ.

An error correction code thus makes it possible to detect and correct the errors generated during the transmission of the data T_{0-q} through the first transmission channel 40 via RF signals.

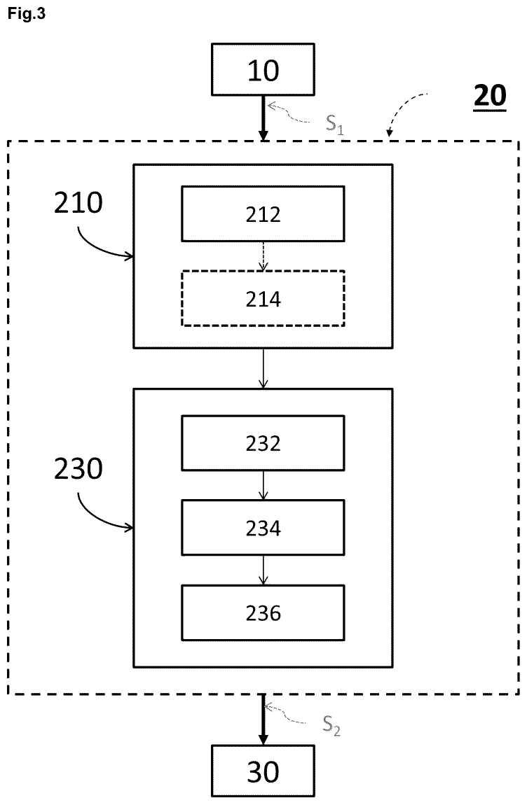

FIG. 3 schematically shows the communication payload of the satellite communication platform 20 comprising an RF signal processing module 210 and an optical signal generation module 230, according to some embodiments of the invention.

The space platform 20 is configured to receive, on the uplink UL, a signal S₁ equivalent to a modulated and encoded radiofrequency signal S_{1-q} or a signal S₁ resulting from an aggregation of multiple modulated and encoded radiofrequency signals S_{1-q}. The space platform 20 is also configured to transmit, on the downlink DL, an optical communication signal S₂.

The space platform 20 is also configured to apply soft demodulation to each of the received signals S_{1-q} in order to determine a plurality of N intermediate demodulated data frames B₁₋ₙ. The optical communication signal S₂ is then generated (or produced) from at least two of the N intermediate demodulated data frames B₁₋ₙ.

The number N of data frames demodulated by the space platform 20 is a positive integer greater than or equal to 2. The parameter ‘n’ designates an index associated with any demodulated data frame, and is an integer between 1 and N. Each received radiofrequency signal corresponds to a radiofrequency communication signal transmitted by one of the devices 10-q of the set 10 of the wireless communication system 1. Those skilled in the art will understand that N data frames demodulated by the space platform 20 may be defined beforehand based on one or more radiofrequency communication signals. For example and without limitation, a received modulated and encoded radiofrequency signal may be associated with a data frame modulated onto the RF signal, or a radiofrequency signal may comprise a plurality of data frames to be processed.

It should be noted that the optical communication signal S₂ may correspond to a set of optical communication sub-signals.

The communication payload may also comprise one or more data storage memories, for example associated with the various units of the radiofrequency signal processing chain for producing the optical signals.

Advantageously, the space platform 20 may comprise an uplink antenna (not shown in the figures), operating in the first set of frequencies λ₁, configured to receive the one or more modulated and encoded radiofrequency signals S_{1-q} from wireless communication terminals 10-q. The space platform 20 may also comprise a downlink antenna (not shown in the figures), also called an optical terminal or telescope, operating in the second set of frequencies λ₂, configured to transmit the optical signal S₂ to the communication station 30.

The RF signal processing module 210 comprises a soft demodulation unit 212 for soft demodulation of the plurality of received RF signals, configured to determine a plurality of N intermediate demodulated data frames B₁₋ₙ.

The RF soft demodulation unit 212 is thus designed to apply soft RF demodulation to the RF signal or to the plurality of modulated and encoded received RF signals in order to determine, for each bit associated with each encoded data frame T₁₋ₙ (or T₁₋ₙ), a soft value (also called metric value) taking into account the probability of induced noise affecting the RF signal through the first transmission channel 40.

As used here, the expression ‘soft value’ refers to a value that is not a hard binary value, such as a “0” or a “1”. In particular, applying the soft RF demodulation results in log-likelihood ratio (or LLR) values being determined. Each LLR value is a real value and corresponds to a ratio between the probability of a bit having a value equal to 0 taking into account the received signal and the probability of this same bit having a bit value equal to 1 taking into account the received signal.

The RF soft demodulation unit 212 is also designed to quantize, on a certain number of bits, each determined soft value (or LLR value) in order to generate the intermediate demodulated data frame B₁₋ₙ.

In particular, an intermediate demodulated data frame B₁₋ₙ may comprise LLR values encoded on a limited number of bits. For example, the LLR values may be encoded on fewer than around ten bits.

In some embodiments, the RF signal processing module 210 may also comprise a soft value frame compression unit 214 configured to reduce the size of the plurality of N intermediate demodulated data frames B₁₋ₙ before they are processed by the optical signal generation module 230.

For example and without limitation, the compression unit 214 may implement an LLR value data compression and quantization algorithm defined on the basis of various optimization procedures. Such a procedure may be that of minimizing the bit error rate between the values of what are referred to as the original LLRs and the values of the LLRs said to be reconstituted by the RF soft demodulation unit 212. Such a procedure may also be that of maximizing the mutual information between the values of the original LLRs and the values of the reconstituted LLRs.

The modulated and encoded radiofrequency signals passing through the first transmission channel 40 are subject to propagation errors or interference as they pass through the atmosphere, according to the Gaussian channel model. Therefore, the soft RF demodulation of RF signals results in a distribution of LLR values that is defined with a Gaussian distribution. Advantageously, the compression unit 214 may implement a frame compression algorithm taking into account such a Gaussian distribution of the LLR values.

For example and without limitation, the compression unit 214 may implement an algorithm taking into account the Gaussian distribution of the LLR values in order to define non-uniform quantization levels of the LLR value data so as to minimize quantization noise from one end to the other of an intermediate demodulated data frame B₁₋ₙ to be compressed.

Such an RF signal processing module 210 according to the embodiments of the invention significantly reduces the complexity in terms of implementing the payload related to the processing of RF signals on a satellite compared with the technological maturity, able to be applied in space, of a complex regenerative architecture. Such an RF signal processing module 210 also allows a significant saving in terms of memory storage of the various frames during the processing of intermediate demodulated data frames (i.e. digitized LLRs) to produce the optical signals.

The optical signal generation module 230 comprises an intermediate demodulated data encoding unit 232 configured to apply a second error correction code to the plurality of N intermediate demodulated data frames B₁₋ₙ so as to determine a plurality of N encoded intermediate demodulated data frames B₂₋ₙ.

For example and without limitation, the second error correction code consists in concatenating an intermediate demodulated data frame B₁₋ₙ with a second redundancy frame Bᵢ to form an encoded intermediate demodulated data frame B₂₋ₙ. The second redundancy frame Bᵢ then corresponds to a set of parity bits, that is to say a set of bits computed with respect to the information bits of the intermediate demodulated data frames B₁₋ₙ.

Advantageously, the application of the second error correction code at the encoding unit 232 may take into account the Gaussian distribution of the LLR values induced by the soft RF demodulation of RF signals.

Moreover, digitizing an LLR value on a number K of bits may result in each k-th bit being associated with a significance index, k being an integer between 1 and K. In particular, the first bit of a digitized LLR value may have the greatest significance index and the last bit of a digitized LLR value may have the lowest significance index. In other words, the bits associated with the greatest (that is to say largest) significance indices represent the most critical or significant parts of the frame (that is to say of the bit stream) in the frame decoding process. These parts may thus benefit from a higher order of protection than the bits associated with the lowest significance indices. Advantageously, for each intermediate demodulated data frame B₁₋ₙ, the application of the second error correction code and/or the application of frame compression may also take into account the significance index of each bit of each of the LLR values of the frame.

For example and without limitation, the second error correction code may apply protection that is more robust, and therefore more costly in terms of number of redundancy bits, to bits with high significance indices, and protection that is more lightweight, that is to say associated with redundancy comprising a small number of redundancy bits, to bits with a low significance index.

For example and without limitation, the encoding unit 232 may implement an algorithm that protects the bits of a frame unequally against errors, taking into account hierarchical modulation codes or multi-level error correction codes.

The optical signal generation module 230 also comprises a data interleaving unit 234 configured to apply an interleaving function to the set of N encoded intermediate demodulated data frames B₂₋ₙ, so as to determine a plurality of M interleaved data frames I₂₋ₘ.

The number M of interleaved data frames is a positive integer greater than or equal to 1. The parameter ‘m’ designates an index associated with any interleaved data frame, and is an integer between 1 and M. The number M may be determined for example based on the number N of encoded intermediate demodulated data frames and/or on the size of each of these frames. In some embodiments, the number M may be equal to the number N.

An interleaving function uses techniques of interleaving (or mixing) bits between various data frames. In particular, some what are referred to as ‘temporal’ interleaving techniques have been developed to counter optical channel fading experienced by optical signals. One example of an interleaving function may correspond to what is known as “row-column” interleaving. Such an interleaving function uses a ‘block interleaver’ that fills in, row by row, a data matrix of N rows and M columns with input bits or symbols defined from the N encoded intermediate demodulated data frames B₂₋ₙ. The interleaving function then determines the M interleaved data frames I₂₋ₘ using the content of each column of the obtained data matrix.

It should be noted that applying an interleaving function, even though it lasts only a few milliseconds, involves storing the set of N data frames B₂₋ₙ to be interleaved in memory. A significant saving is thus obtained in terms of storage by using LLR values encoded on fewer than around ten bits, thereby making it possible to achieve communications dedicated to very high-throughput services while limiting the expansion of the optical band.

The optical signal generation module 230 also comprises an optical carrier modulation unit 236 configured to modulate an optical signal so as to form an optical communication signal S₂ to be transmitted via the downlink telescope through the second transmission channel 50. For example and without limitation, such modulation may be phase modulation, amplitude modulation, frequency modulation, or any combination of modulations, such as phase and amplitude modulation. Modulation onto optical carriers is applied by encoding the plurality of M interleaved data frames I₂₋ₘ onto the optical signal.

The optical signal may be modulated, for example and without limitation, based on amplitude and phase-shift keying (APSK), quadrature amplitude modulation (QAM), modulation from the family of phase-shift keying (PSK) such as BPSK modulation (Bi or 2-PSK with two possible phase values), QPSK modulation (Quad or 4-PSK with four possible phase values), or else DPSK (differential-PSK) modulation.

The use of an RF signal soft demodulation unit 212 in the processing module 210 of the satellite makes it possible to use a reduced spectral band size on the optical channel. By way of illustration, for LLR values represented on fewer than around ten bits, the width of the spectral band occupied by the signal S₂ may be reduced by up to 8 times compared to the spectral band occupied by an optical signal transmitted by a transparent digital architecture.

In some embodiments, the signal S₂ may be transmitted to the communication station 30 from a space or airborne optical signal relay platform.

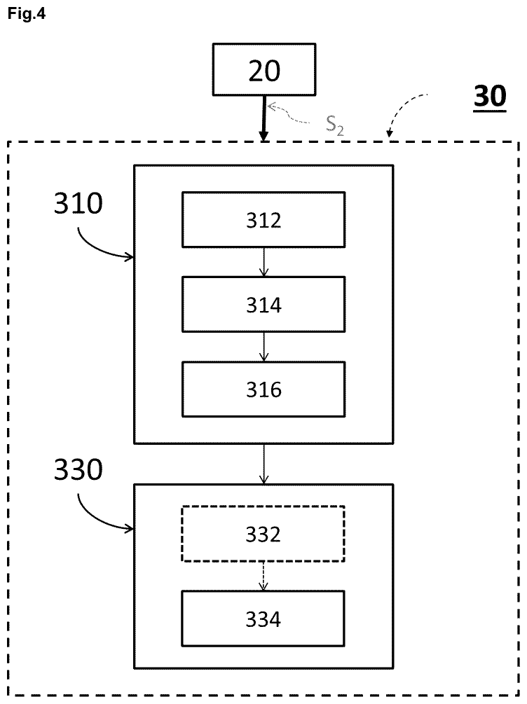

FIG. 4 schematically shows a communication station 30 comprising an optical signal processing module 310 and a data reconstruction module 330, according to some embodiments of the invention.

The communication station 30 is configured to receive the resultant signal S₂ transmitted by the space platform 20 on the link DL, and to reconstitute the initial data frames T₀₋ₙ.

Advantageously, the communication station 30 comprises a telescope (not shown in the figures), operating in the second set of frequencies λ₂, configured to receive the optical signal S₂ from the space platform 20.

The optical signal processing module 310 comprises a demodulation unit 312 configured to demodulate the received optical signal S₂ in order to determine a plurality of M demodulated interleaved data frames I*₂₋ₘ.

The demodulation applied by the unit 312 may be defined as a function of the modulation of the optical signal applied by the communication payload of the space platform 20, before the transmission of the optical signal S₂. Each demodulated interleaved data frame I*₂₋ₘ then corresponds to the associated interleaved data frame I₂₋ₘ taking into account the optical channel fading experienced by the optical signal.

The optical signal processing module 310 also comprises a data deinterleaving unit 314 configured to apply a deinterleaving function to the set of M demodulated interleaved data frames I*₂₋ₘ, so as to determine a plurality of N deinterleaved data frames B*₂₋ₙ.

The deinterleaving function uses techniques of reordering bits of the various data frames. Each deinterleaved data frame B*₂₋ₙ then corresponds to the associated encoded intermediate demodulated data frame B₂₋ₙ taking into account the optical channel fading experienced by optical signals.

Advantageously, the deinterleaving function applied by the unit 314 may be defined as a function of the interleaving applied by the communication payload of the space platform 20 before the transmission of the optical signal S₂.

The optical signal processing module 310 also comprises a transmitted data decoding unit 316 configured to apply a decoding function to the set of N deinterleaved data frames B*₂₋ₙ, so as to determine a plurality of N decoded data frames B*₁₋ₙ.

The decoding function implemented in the unit 316 may be defined as a function of the encoding of intermediate demodulated data (that is to say quantized LLR values) of the communication payload of the space platform 20 corresponding to the error correction code under consideration in the module 232. Each decoded data frame B*₁₋ₙ then corresponds to the associated intermediate demodulated data frame B₁₋ₙ taking into account the optical channel fading experienced by optical signals.

For example and without limitation, the decoding function implemented in the unit 316 may be a reciprocal function of the concatenation function of the second redundancy frame Bᵢ applied to the deinterleaved data frames B*₂₋ₙ.

Advantageously, such a decoding function may be implemented taking into account the expected Gaussian distribution of the LLR values found for each decoded data frame B*₁₋ₙ.

Moreover, such a decoding function may be implemented taking into account the significance index of each bit of each of the LLR values found for each decoded data frame B*₁₋ₙ.

In embodiments in which the RF signal processing module 210 of the space platform 20 comprises a soft value frame compression unit 214, the data reconstruction module 330 may comprise a soft value frame decompression unit 332 configured to reconstitute the LLR components of the decoded and advantageously compressed data frame B*₁₋ₙ.

For example and without limitation, the soft value frame decompression unit 332 may be defined as a function of the compression applied by the compression unit 214 of the space platform 20.

In addition, the data reconstruction module 330 may comprise a soft decoding unit 334 configured to apply a decoding function to the set of N decoded data frames B*₁₋ₙ (which data may optionally be decompressed), so as to determine a plurality of N regenerated data frames T*₀₋ₙ. The LLR values, thus retrieved at the output of the module 316 (or optionally 332), are fed to the algorithm for decoding the first error correction code of the soft decoding unit 334, the first error correction code having been implemented at the data encoding module 112-q of the signal generation module 110-q of the wireless communication terminal 10-q.

Each regenerated data frame T*₀₋ₙ (or T*_{0-q}) then corresponds to the associated initial data frame T₀₋ₙ (or T_{0-q}) reconstituted (that is to say regenerated) taking into account the optical channel fading experienced by the one or more optical signals and the losses experienced by the radiofrequency signals. Such decoding, implemented for example in the form of iterative soft decoding, enables a code or redundancy gain that is sufficient to reconstruct the initial data frames T₀₋ₙ from the LLR values reconstituted at the output of the module 310.

The algorithm used for decoding encoded binary data may be for example an FEC decoding algorithm corresponding to the type of error correction codes used in the module 110-q (that is to say a Viterbi algorithm, what is known as a ‘BCJR’ algorithm, a belief propagation algorithm, a turbo-decoding algorithm, etc.).

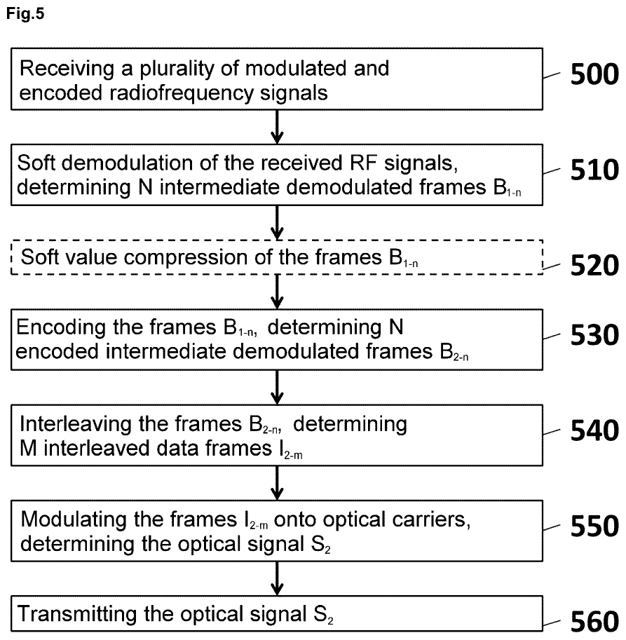

FIG. 5 is a flowchart showing the steps of the optical signal transmission method implemented by the communication satellite 20 (and in particular by the communication payload of the space platform), according to some embodiments of the invention.

In step 500, a radiofrequency signal or a plurality of modulated and encoded radiofrequency signals is/are received by the communication satellite 20.

In step 510, soft demodulation of the one or more received RF signals is applied in order to determine N intermediate demodulated frames B₁₋ₙ.

In step 520, compression of the N intermediate demodulated frames B₁₋ₙ may be applied.

In step 530, encoding of the N intermediate demodulated frames B₁₋ₙ is applied in order to determine N encoded intermediate demodulated frames B₂₋ₙ, the applied encoding corresponding to a function associated with a second error correction code.

In step 540, interleaving of the N encoded intermediate demodulated frames B₂₋ₙ is applied in order to determine M interleaved frames I₂₋ₘ.

In step 550, modulation of the M interleaved frames I₂₋ₘ onto one or more optical carriers is carried out in order to determine a (resultant) optical signal S₂.

In step 560, the optical signal S₂ is transmitted by the communication satellite 20, via the optical transmission channel.

The modulation, encoding and compression operations are implemented according to the embodiments described above.

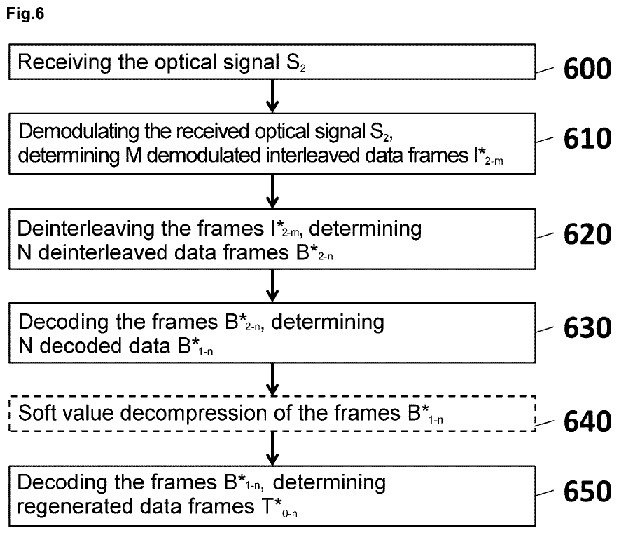

FIG. 6 is a flowchart showing the method for receiving the one or more optical signals, implemented by the communication station 30, according to some embodiments of the invention, in order to reconstitute the initial data frames associated with the received optical signals.

In step 600, the (resultant) optical signal S₂, transmitted by the communication satellite 20, via the optical transmission channel, is received by the communication station 30.

In step 610, demodulation of the received optical signal S₂ is applied in order to determine M demodulated interleaved data frames I*₂₋ₘ.

In step 620, deinterleaving of the M demodulated interleaved data frames I*₂₋ₘ is applied in order to determine N deinterleaved data frames B*₂₋ₙ.

In step 630, decoding of the N deinterleaved data frames B*₂₋ₙ is applied in order to determine N decoded data frames B*₁₋ₙ. Such applied decoding may correspond to a reciprocal function of the second error correction code implemented at the communication satellite 20.

In step 640, soft value frame decompression may be applied in order to determine (or reconstitute) the LLR components of each of the N decoded frames B*₁₋ₙ. Such applied decompression may be applied as a function of the compression of the intermediate demodulated frames implemented at the space platform 20.

In step 650, decoding of the N decoded data frames B*₁₋ₙ is applied in order to determine N regenerated data frames T*₀₋ₙ. Such applied decoding may correspond to a reciprocal function of the first correction code implemented at a wireless communication terminal 10-q.

The demodulation, decoding and decompression operations are implemented according to the embodiments described above.

Those skilled in the art will understand that the wireless communication elements of the system, according to the embodiments of the invention, may be implemented in various ways by hardware, software, or a combination of hardware and software, notably in the form of program code that may be distributed as a program product, in various forms. The program code may be distributed using computer-readable media, which may include computer-readable storage media and communication media. The methods described in the present description may be implemented notably in the form of computer program instructions able to be executed by one or more processors in a computer-based computing device. For example, the digital processing operations in the methods of the invention may be implemented on FPGAs or ASICs. These computer program instructions may also be stored in a computer-readable medium.

The invention is not limited to the embodiments described above by way of non-limiting examples. It encompasses all variant embodiments that might be envisaged by those skilled in the art. In particular, those skilled in the art will readily understand that the invention is not limited to the various modules of the space platform and of the communication station that are described by way of non-limiting examples.

Moreover, those skilled in the art will readily understand that the present invention may be implemented in any NTN architecture involving equipments other than satellites operating at various altitudes lower than the deployment altitudes of what are referred to as ‘typical’ satellites, depending on the implementation, spectrum allocation and/or service coverage. For example and without limitation, such equipments may be one or more airborne or space vehicles configured for communications, such as high-altitude or low-altitude platform stations, aircraft systems or unmanned aerial vehicles (also called drones), etc.

1. A communication satellite configured to transmit an optical signal, through an optical transmission channel, in response to the reception of at least one modulated and encoded radiofrequency signal, wherein said satellite comprises:
a soft demodulation unit configured to apply soft demodulation to said at least one received radiofrequency signal, thereby providing a plurality of N intermediate demodulated data frames B₁₋ₙ, each intermediate demodulated data frame B₁₋ₙ comprising a set of digitized soft values;
an encoding unit configured to apply an error correction code to said intermediate demodulated data frames B₁₋ₙ, thereby providing a plurality of N encoded intermediate demodulated data frames B₂₋ₙ;
an interleaving unit configured to interleave said N encoded intermediate demodulated data frames B₂₋ₙ, thereby providing M interleaved data frames I₂₋ₘ; and
an optical carrier modulation unit configured to apply, to each interleaved data frame I₂₋ₘ, an optical carrier modulation so as to form said optical signal.

2. The communication satellite according to claim 1, wherein, for each intermediate demodulated data frame B₁₋ₙ, the digitized soft values are defined with a Gaussian distribution, and wherein said error correction code applied by said encoding unit takes into account said Gaussian distribution of the digitized soft values of the frames B₁₋ₙ.

3. Communication The communication satellite according to claim 1, wherein, for each intermediate demodulated data frame B₁₋ₙ, each quantization bit of the digitized soft values is associated with a significance index, and wherein said error correction code applied by said encoding unit takes into account said significance index of the bits of the digitized soft values of the frames B₁₋ₙ.

4. A communication station configured to receive, through an optical transmission channel, an optical signal from a satellite and associated with a plurality of initial data frames T_{0-q}, wherein said communication station comprises:
a demodulation unit configured to demodulate said received optical signal, thereby providing M demodulated interleaved data frames I*₂₋ₘ;
a deinterleaving unit configured to deinterleave the M demodulated interleaved data frames I*₂₋ₘ, thereby providing a plurality of N deinterleaved data frames B*₂₋ₙ;
a decoding unit configured to apply a reciprocal function of an error correction code to said deinterleaved data frames B*₂₋ₙ, thereby providing a plurality of N decoded data frames B*₁₋ₙ, each frame B*₁₋ₙ comprising a set of digitized soft values; and
a decoding unit configured to apply a digitized soft value decoding function to the set of N decoded data frames B*₁₋ₙ, thereby providing a plurality of N regenerated data frames T*₀₋ₙ, each regenerated data frame T*₀₋ₙ corresponding to a reconstituted initial data frame T₀₋ₙ.

5. The communication station according to claim 4, wherein said reciprocal function of said error correction code applied by said decoding unit takes into account a Gaussian distribution of the soft values of the generated decoded data frames B*₁₋ₙ.

6. The communication station according to claim 4, wherein said reciprocal function of said error correction code applied by said decoding unit takes into account a significance index associated with each bit of the soft values of the generated decoded data frames B*₁₋ₙ.

7. A wireless communication system comprising, a communication satellite configured to transmit an optical signal, through an optical transmission channel. in response to the reception of at least one modulated and encoded radiofrequency signal, wherein said satellite comprises:
a soft demodulation unit configured to apply soft demodulation to said at least one received radiofrequency signal, thereby providing a plurality of N intermediate demodulated data frames B₁₋ₙ, each intermediate demodulated data frame B₁₋ₙ comprising a set of digitized soft values;
an encoding unit configured to apply an error correction code to said intermediate demodulated data frames B₁₋ₙ, thereby providing a plurality of N encoded intermediate demodulated data frames B₂₋ₙ;
an interleaving unit configured to interleave said N encoded intermediate demodulated data frames B₂₋ₙ, thereby providing M interleaved data frames I₂₋ₘ; and
an optical carrier modulation unit configured to apply, to each interleaved data frame I₂₋ₘ, an optical carrier modulation so as to form said optical signal, and
a communication station according to claim 4, which are connected by an optical transmission channel, and in that the communication station is configured to receive said optical signal from the communication satellite, through said optical transmission channel, said reciprocal function being the reciprocal function of the error correction code applied by the communication satellite.

8. The wireless communication system according to claim 7, wherein said communication satellite furthermore comprises a soft value frame compression unit and said communication station furthermore comprises a soft value frame decompression unit.

9. A method for transmitting an optical signal, the method being implemented in a communication satellite connected to an optical transmission channel, the method comprising the following steps:
receiving at least one modulated and encoded radiofrequency signal;
applying soft demodulation to said at least one received radiofrequency signal in order to determine a plurality of N intermediate demodulated data frames B₁₋ₙ, each frame B₁₋ₙ comprising a set of digitized soft values;
applying an error correction code to said intermediate demodulated data frames B₁₋ₙ in order to determine a plurality of N encoded intermediate demodulated data frames B₂₋ₙ;
applying an interleaving function to said encoded intermediate demodulated data frames B₂₋ₙ in order to determine M interleaved data frames I₂₋ₘ;
applying optical carrier modulation to each interleaved data frame I₂₋ₘ, thereby providing said optical signal; and
transmitting said optical signal through said optical transmission channel.

10. The method for receiving an optical signal from a satellite, the method being implemented by a communication station connected to an optical transmission channel, the method comprising the following steps:
receiving said optical signal associated with a plurality of initial data frames T_{0-q}, through said optical transmission channel;
applying demodulation to said received optical signal, thereby providing M demodulated interleaved data frames I*₂₋ₘ;
applying a deinterleaving function to said demodulated interleaved data frames I*₂₋ₘ, thereby providing a plurality of N deinterleaved data frames B*₂₋ₙ;
applying a reciprocal function of an error correction code to said deinterleaved data frames B*₂₋ₙ, thereby providing a plurality of N decoded data frames B*₁₋ₙ, each frame B*₁₋ₙ comprising a set of digitized soft values; and
applying a digitized soft value decoding function to the set of N decoded data frames B*₁₋ₙ in order to determine a plurality of N regenerated data frames T*₀₋ₙ, each regenerated data frame T*₀₋ₙ corresponding to a reconstituted initial data frame T₀₋ₙ.
